(19) United States
(12) Patent Application Publication
(10) Pub. No.: US 2011/0083912 A1
(43) Pub. Date: Apr. 14, 2011

(54) Electromagnetic Whiteboard Eraser

(75) Inventors: Jen-Shuo Liu, Hsin-Chu (TW); Cheng-Lu Liu, Hsin-Chu (TW); Yan-Chin Hsu, Hsin-Chu (TW)

(73) Assignee: WALTOP INTERNATIONAL CORPORATION, Hsinchu (TW)

(21) Appl. No.: 12/639,798

(22) Filed: Dec. 16, 2009

(30) Foreign Application Priority Data
Oct. 13, 2009 (TW) 098218844

(51) Int. Cl. G06K 11/06; G08B 21/00; G06F 3/033

(52) U.S. Cl. 178/19.01; 340/636.1; 345/179

(57) ABSTRACT

An electromagnetic whiteboard eraser is disclosed, and particular an electromagnetic whiteboard eraser capable of erasing both of the writing written by ink and the writing inputted by electromagnetic induction simultaneously. The electromagnetic whiteboard eraser has an ink eraser for erasing the writing written by ink and a coil for emitting electromagnetic signals. An electromagnetic whiteboard defines an erasing area for erasing the writing inputted by electromagnetic induction by defining the position of the coil to be the center of the erasing area and defining the diameter or radius of the ink eraser to be the diameter or radius of the erasing area after the electromagnetic whiteboard induces the electromagnetic signals emitted by the coil. The coil is deposed on the place corresponding to the center of the ink eraser. Therefore, the erasing area and the ink eraser are matched together completely and the writing inputted by electromagnetic induction can be erased by the electromagnetic whiteboard eraser simultaneously when the writing written by ink is erased by the ink eraser.

### FIELD OF THE INVENTION

The present invention relates to an electromagnetic whiteboard eraser, and particularly relates to an electromagnetic whiteboard eraser capable of erasing both of the writing written by ink and the writing inputted by electromagnetic induction simultaneously.

### BACKGROUND OF THE INVENTION

A conventional electric whiteboard is a whiteboard having a scanner so the conventional electric whiteboard can roll the writing surface to the backside of the conventional electric whiteboard for scanning. Therefore, the information written on the writing surface, for example words, drawings, or the writing written by ink, is printed by a printer or stored in a memory. Because the scanner is applied in the conventional electric whiteboard to scan the writing written on the writing surface by ink, it has no need of orientating the conventional whiteboard pen and the conventional whiteboard eraser or of finding the positions of the conventional whiteboard pen and the conventional whiteboard eraser. Therefore, the conventional whiteboard pen and the conventional whiteboard eraser applied to the common whiteboard (not electric whiteboard) also can apply to the conventional electric whiteboard for writing and erasing. In other words, the conventional whiteboard pen, which can outputs ink to write, can be used to write on the conventional electric whiteboard directly, and the conventional whiteboard eraser, which only can erase the writing written by ink, can be used to erase the writing written on the conventional electric whiteboard can be erased directly. The information written on the conventional electric whiteboard by ink is scanned, printed or stored only by the scanner so the conventional whiteboard pen and the conventional whiteboard eraser are not involved in the scanning, printing or storing. Therefore, the user can use the conventional whiteboard pen and the conventional whiteboard eraser to write and erase on the conventional electric whiteboard directly.

However, with the trend that the electromagnetic induction technique is applied to the electric whiteboard largely. Therefore, the electric whiteboard is developed to be an electromagnetic whiteboard capable of inputting the writing (or information), which is written by ink, into the electromagnetic whiteboard by the electromagnetic induction simultaneously for converting the information to digital information to be stored when the writing (or information) is written thereon with ink. Because a pointer device is capable of outputting ink to write and emitting the electromagnetic signals simultaneously, such as an electromagnetic pen, the electromagnetic whiteboard can record the positions and the moving trace of the pointer device. Therefore, when the pointer device writes on the electromagnetic whiteboard by ink, the information written on the electromagnetic whiteboard by ink is inputted in the electromagnetic whiteboard by the electromagnetic induction simultaneously. However, because the conventional whiteboard eraser can not emit the electromagnetic signals, the electromagnetic whiteboard can not record the positions and the moving trace of the conventional whiteboard eraser to define an erasing area for erasing the writing inputted by the electromagnetic induction. Therefore, the conventional whiteboard eraser only can erase the writing written by ink but it can not erase the information (or the writing) which is inputted by the electromagnetic induction and stored in the electromagnetic whiteboard. Accordingly, the conventional whiteboard eraser can be applied to the electromagnetic whiteboard.

Therefore, in view of foregoing drawbacks of conventional whiteboard eraser, there is a need to provide an electromagnetic whiteboard eraser capable of being applied to the electromagnetic whiteboard and capable of erasing both of the writing written by ink and the writing inputted by electromagnetic induction simultaneously.

### SUMMARY OF THE INVENTION

An objective of this invention is to provide an electromagnetic whiteboard eraser capable of being applied to the electromagnetic whiteboard and capable of erasing both of the writing written by ink and the writing inputted by electromagnetic induction simultaneously. The electromagnetic whiteboard eraser can move toward any sides of the electromagnetic whiteboard eraser to erase on the electromagnetic whiteboard but the electromagnetic whiteboard does not define a wrong erasing area. Even the electromagnetic whiteboard eraser rotates to erase on the electromagnetic whiteboard, the electromagnetic whiteboard does not define a wrong erasing area.

In one embodiment of the present invention, an electromagnetic whiteboard eraser is disclosed and this electromagnetic whiteboard eraser is capable of being applied to the electromagnetic whiteboard and capable of erasing both of the writing written by ink and the writing inputted by electromagnetic induction simultaneously. The electromagnetic whiteboard comprises an eraser body, a control board deposed in the eraser body, a coil deposed in the eraser body and an ink eraser deposed on the bottom of the eraser body. The eraser body is used for the user to hold the electromagnetic whiteboard eraser with hand to erase the writing written by ink and the writing inputted by electromagnetic induction. The control board is deposed in the eraser body for controlling the electromagnetic whiteboard eraser to work or operate. Furthermore, the coil is deposed in the eraser body for emitting the electromagnetic signals. The ink eraser is used for erasing the writing written on the writing surface of the electromagnetic whiteboard by ink. When the electromagnetic whiteboard eraser erases the writing written by ink, the coil emits the electromagnetic signals to the electromagnetic whiteboard for the electromagnetic whiteboard to induce the electromagnetic signals. Therefore, the electromagnetic whiteboard records the positions and the moving trace of the electromagnetic whiteboard eraser to erase the information in the erasing area which is inputted into the electromagnetic whiteboard by the electromagnetic induction. The erasing area has the same shape and size with the ink eraser and the erasing area completely overlaps the ink eraser.

Therefore, the effect achieved with the present invention is to provide an electromagnetic whiteboard eraser. The electromagnetic whiteboard records the positions and the moving trace of the electromagnetic whiteboard eraser for defining an erasing area by inducing the electromagnetic signals emitted by the coil, and then, the electromagnetic whiteboard erases the writing (or the information) inputted by the electromagnetic induction in the erasing area. The erasing area has the same shape and size with the ink eraser and the erasing area completely overlaps the ink eraser. Accordingly, the electromagnetic whiteboard eraser can erase both of the writing (or the information) written by ink and the writing (or the information) inputted by the electromagnetic induction simultaneously and the electromagnetic whiteboard eraser can be applied to the electromagnetic whiteboard.

### BRIEF DESCRIPTION OF THE DRAWINGS

FIGS. 1A, 1B, 1C and 1D are a top view diagram, a side view diagram, a bottom view diagram and a front view diagram respectively illustrating an electromagnetic whiteboard eraser in accordance with one embodiment of the present invention.

FIG. 2A is exploded diagram illustrating an electromagnetic whiteboard eraser in accordance with one embodiment of the present invention.

FIGS. 2B and 2C are a bottom view diagram and a perspective form diagram respectively illustrating the bottom housing of the electromagnetic whiteboard eraser in accordance with one embodiment of the present invention.

### DESCRIPTION OF THE EXEMPLARY EMBODIMENTS

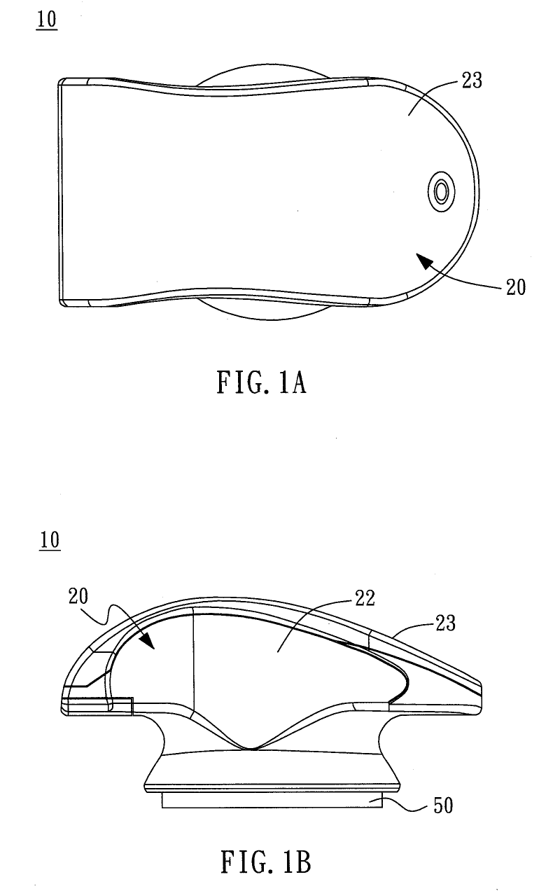

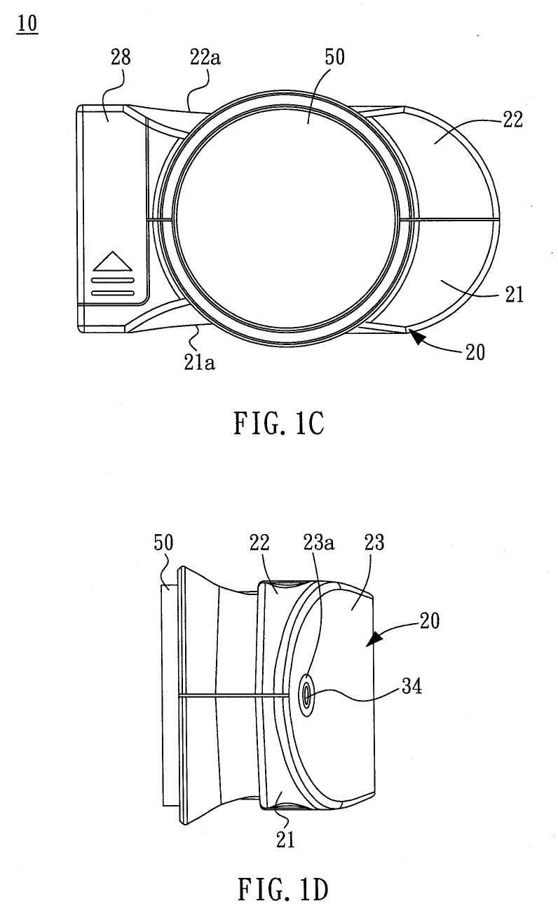

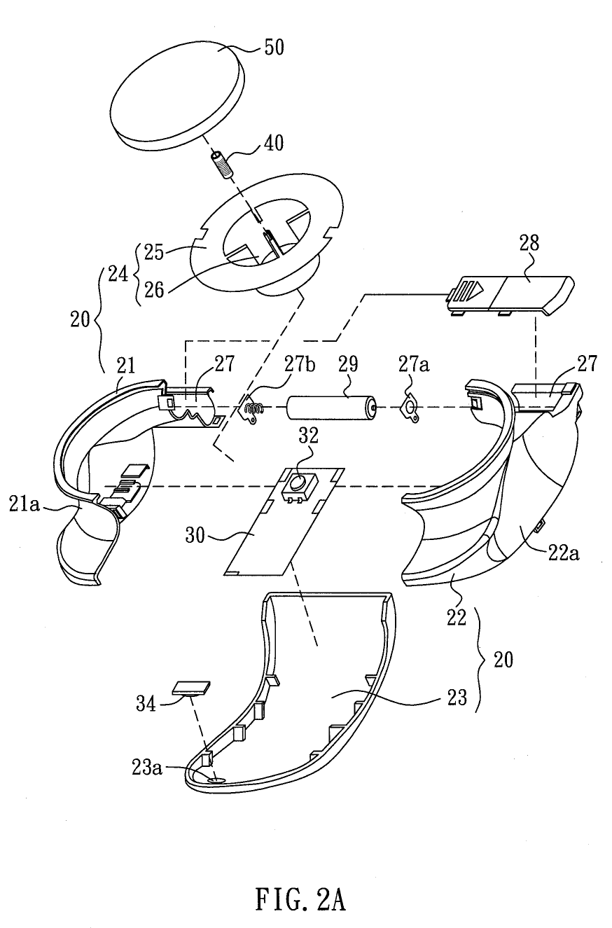

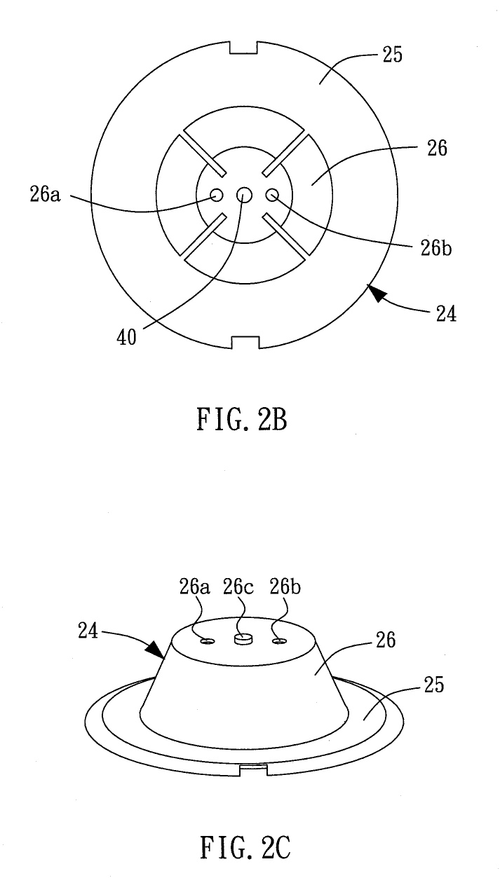

FIGS. 1A, 1B, 1C and 1D are a top view diagram, a side view diagram, a bottom view diagram and a front view diagram respectively illustrating the electromagnetic whiteboard eraser 10 in accordance with one embodiment of the present invention. FIG. 2A is exploded diagram illustrating an electromagnetic whiteboard eraser 10. The electromagnetic whiteboard eraser 10 consists of an eraser body 20, a control board 30, a coil 40 and an ink eraser 50.

Referring to FIGS. 1A, 1B, 1C, 1D and 2A simultaneously, the eraser body 20 is the main body of the electromagnetic whiteboard eraser 10 for containing the control board 30 and coil 40 and for the user to hold the electromagnetic whiteboard eraser 10 with hand to erase the writing (or information) written by ink and the writing (or information) inputted by the electromagnetic induction. The eraser body 20 comprises four elements of a left side housing 21, a right side housing 22, a top housing 23 and a bottom housing 24, and the four housings form the eraser body 20 capable of containing the control board 30 and coil 40 therein. In this embodiment, although the left side housing 21, the right side housing 22, the top housing 23 and the bottom housing 24 can be disassembled to be four independent housing, but in another embodiment, any two or three housings of the left side housing 21, the right side housing 22, the top housing 23 and the bottom housing 24 are integrated as one member (or housing), for example the left side housing 21 and the right side housing 22 are integrated as one member (or housing) or the left side housing 21, the right side housing 22 and the top housing 23 are integrated as one member (or housing).

Both of the left side housing 21 and the right side housing 22 have a holding member 21a, 22a respectively outside the left side housing 21 and the right side housing 22 for the user to conveniently take and use the electromagnetic whiteboard eraser 10 with hand. In this embodiment, the holding member 21a and 22a are the concaves which are respectively sunken toward the inner of the left side housing 21 and the right side housing 22 for the user to hold with hand conveniently. The bottom housing 24 has a circular bottom 25 and a holding cavity 26 deposed in the center area of the circular bottom 25, and the holding cavity 26 is sunken upward (it means that the holding cavity 26 sunken toward the inner of the eraser body 20) for holding the coil 40 therein. The holding cavity 26 is a circular cavity and the center of the holding cavity 26 (the center of the circle of the holding cavity 26) corresponds to the center of the circular bottom 25 (the center of the circle of the circular bottom 25). The coil 40 is deposed at the center of the holding cavity 26 and the coil 40 corresponds to the center of the circular bottom 25. It means that the coil 40 is deposed at both of the centers of the circular bottom 25 and the holding cavity 26. In another embodiment, the holding cavity can be fabricated in various shapes according to the demand and the design, and the coil is deposed in the holding cavity to correspond to the center of the circular bottom. Therefore, the coil is still deposed at the center of the circular bottom.

Referring to FIGS. 2B and 2C, they are a bottom view diagram and a perspective form diagram respectively illustrating the bottom housing 24 of the electromagnetic whiteboard eraser 10 in accordance with one embodiment of the present invention. The holding cavity 26 has two holes 26a, 26b on the top of the holding cavity 26 for passing the two ends of the coil 40 through the holes 26a, 26b to be connected with the control board 30 respectively. Furthermore, a controlling member 26c is deposed on the top of the holding cavity 26. The controlling member 26c is a protrusion sunken upward. It means that the controlling member 26c is a protrusion sunken toward the inner of the electromagnetic whiteboard eraser 10.

Besides, the eraser body 20 has a battery container 27 deposed therein for putting a battery 29 the battery container 27 to be a power supply of the electromagnetic whiteboard eraser 10. The battery container 27 has a positive contact 27a for contacting with the positive electrode of the battery 27 and a negative contact 27b for contacting with the negative electrode of the battery 27. Therefore, the electric energy or power of the battery 29 is outputted to the electromagnetic whiteboard eraser 10. Furthermore, the eraser body 20 has a battery cover 28 for sealing the battery 29 in the battery container 27 and for changing the battery 29.

The coil 40 deposed in the eraser body 20 is used to emit a first electromagnetic signal or a second electromagnetic signal, and the electromagnetic whiteboard induces the electromagnetic signals to record the positions and the moving trace of the electromagnetic whiteboard eraser in the electromagnetic whiteboard for defining an erasing area and for erasing the writing (or information) which is in the erasing area and inputted by the electromagnetic induction in the erasing area. The erasing area has the same shape and size with the ink eraser 50 and the erasing area completely overlaps the ink eraser 50. The first electromagnetic signal and said second electromagnetic signal have different frequencies, and the first electromagnetic signal is an original electromagnetic signal and the second electromagnetic signal is an erasing electromagnetic signal defined by the electromagnetic whiteboard. Only when the electromagnetic whiteboard induces the second electromagnetic signal, the writing (or information) written by the electromagnetic induction is erased by the electromagnetic whiteboard eraser 10.

Referring to FIG. 2A, the control board 30 is deposed in the eraser body 20 for controlling the electromagnetic whiteboard eraser 10 to work or operate, for example to emit the electromagnetic signal, to convert the frequency of the electromagnetic signal emitted by the coil 40, and to warn the user of the low power state of the battery. The control board 30 has an oscillating circuit and a detecting circuit (not show in the drawings) deposed in or on the control board 30. The oscillating circuit is used for controlling the coil 40 to emit the electromagnetic signals, for example the first electromagnetic signal or the electromagnetic signal. The detecting circuit is used for detecting the state of voltage of the battery 29 or the state of charge of the battery 29. Furthermore, a signal converting switch 32 is deposed on the bottom of the control board 30 for converting the electromagnetic signal emitted by the coil 40 from the first electromagnetic signal to the second electromagnetic signal or from the second electromagnetic signal to the first electromagnetic signal. The signal converting switch 32 is controlled by the controlling member 26c deposed on the top of the holding cavity 26.

When the electromagnetic whiteboard eraser 10 is putted on the electromagnetic whiteboard to erase, the ink eraser 50 deposed the bottom housing 24 is contacted with the electromagnetic whiteboard. Therefore, both of the ink eraser 50 and the bottom housing 24 are pressed to bring the controlling member 26c to move upward to press or push the signal converting switch 32 for turning on the signal converting switch 32, and then, the signal converting switch 32 controls the coil 40 to convert the electromagnetic signal emitted by the coil 40 from the first electromagnetic signal to the second electromagnetic signal for starting to erase on the electromagnetic whiteboard. Because the second electromagnetic signal is the erasing electromagnetic signal, the electromagnetic whiteboard records the positions and the moving trace of the electromagnetic whiteboard eraser 10 when the electromagnetic whiteboard induces the second electromagnetic signal. And then, the electromagnetic whiteboard defines the position where the electromagnetic whiteboard induces the second electromagnetic signal to be the center of the erasing area and defines a predetermined distance to be the diameter or radius of the erasing area for forming a circular erasing area. The writing (or information) written in the circular erasing area by the electromagnetic induction is erased by the electromagnetic whiteboard eraser 10.

When the electromagnetic whiteboard eraser 10 moves away from the electromagnetic whiteboard, the ink eraser 50 is no longer contacted with the electromagnetic whiteboard and no longer pressed by the electromagnetic whiteboard. Therefore, the bottom housing 24 brings the controlling member 26c to return to the original position and stops pressing or pushing the signal converting switch 32 for turning off the signal converting switch 32, and then, the signal converting switch 32 controls the coil 40 to converts the electromagnetic signal emitted by the coil 40 from the second electromagnetic signal to the first electromagnetic signal for stopping erasing on the electromagnetic whiteboard. Because the first electromagnetic signal is the original electromagnetic signal but not the erasing electromagnetic signal defined by the electromagnetic whiteboard, the electromagnetic whiteboard stops recording the positions and the moving trace of the electromagnetic whiteboard eraser 10 when the electromagnetic whiteboard induces the first electromagnetic signal. In one word, the coil 40 always emits the first electromagnetic signal when the signal converting switch 32 of the electromagnetic whiteboard eraser 10 is not pressed or pushed, and the coil 40 does not emit the second electromagnetic signal until the signal converting switch 32 is pressed or pushed to be turn on.

The ink eraser 50 is deposed on the bottom of the electromagnetic whiteboard eraser 10 for erasing the writing (or information) written by ink, and it means that the ink eraser 50 is deposed under the bottom housing 24. The ink eraser 50 is a circular eraser having the same shape and size with the circular bottom 25, and the ink eraser 50 is exchangeable eraser adhered to the bottom housing 24. When the ink eraser 50 is too dirty to be used, the user can take off the dirty ink eraser and change a new ink eraser 50. Because the ink eraser 50 has the same shape and size with the circular bottom 25 and the ink eraser 50 is adhered to the circular bottom 25 center to center, the coil 40 will also correspond to the center of the ink eraser 50 when the coil 40 is deposed in the holding cavity 26 to correspond to the center of the circular bottom 25. Therefore, when the electromagnetic whiteboard induces the second electromagnetic signal, the electromagnetic whiteboard calculates and finds the position of the electromagnetic whiteboard eraser 10 according to the intensity of the magnetic field induced by the electromagnetic whiteboard. The electromagnetic whiteboard defines the position of the electromagnetic whiteboard eraser 10 calculated and found by the electromagnetic whiteboard to be the center of the erasing area and defines the diameter or radius of the ink eraser 50 to be the diameter or radius of the erasing area for defining the circular erasing area. The circular erasing area has the same shape and size with the ink eraser 50 and completely overlaps the ink eraser 50. In other words, the electromagnetic whiteboard defines the position of the electromagnetic whiteboard eraser 10 calculated and found by the electromagnetic whiteboard to be the center of the erasing area and defines the diameter or radius of the circular bottom 25 to be the diameter or radius of the erasing area for defining the circular erasing area. And then, the writing (or information), for example words, drawings and etc., inputted by the electromagnetic induction in the erasing area is erased. By this way, when the writing (or information) written on the writing surface of the electromagnetic whiteboard by ink is erased by the ink eraser 50 of the electromagnetic whiteboard eraser 10, the electromagnetic whiteboard defines a circular erasing area having the same size with the ink eraser 50 according to the position and the moving trace of the electromagnetic whiteboard eraser 10 and records the position and the moving trace of the circular erasing area for erasing the writing (or information) inputted by the electromagnetic induction. Therefore, the writing (or information) written by ink and writing (or information) inputted by the electromagnetic induction are erased simultaneously.

Furthermore, because the ink eraser 50 and the circular erasing area defined by the electromagnetic whiteboard have the same center and diameter (or radius) and the circular erasing area completely overlaps the ink eraser 50, the distances from the center of the circular erasing area (or the position of the coil 40) to any point at the circumference of the ink eraser 50 or the circular bottom 25 are the same. Therefore, no matter the electromagnetic whiteboard eraser 10 moves on the electromagnetic whiteboard toward any direction, the way to define the erasing area and the size of the erasing area are not changed according to the direction which the electromagnetic whiteboard eraser 10 moves toward. By this way, the electromagnetic whiteboard eraser 10 can freely erase on the electromagnetic whiteboard by any way and toward any direction. Even the electromagnetic whiteboard eraser 10 is rotated to erase on the electromagnetic whiteboard, it cannot influence the judgment of the electromagnetic whiteboard to result in the erroneous judgment of the electromagnetic whiteboard. However, if the ink eraser and the bottom with other shape are used instead of the circular ink eraser 50 and the circular bottom 25, for example the rectangular ink eraser and the rectangular bottom, the distances from the center of the rectangular ink eraser and the rectangular bottom, which the coil is deposed at, to each side of the rectangular ink eraser or the rectangular bottom are different. In this example, although a rectangular erasing area can be defined by the electromagnetic whiteboard, but the electromagnetic whiteboard cannot recognize that the electromagnetic whiteboard eraser having rectangular ink eraser and the rectangular bottom moves toward the long side of the rectangular ink eraser (or the rectangular bottom) or toward the short side of the rectangular ink eraser (or the rectangular bottom). No matter the electromagnetic whiteboard eraser having rectangular ink eraser and the rectangular bottom moves toward the long side or the short, the electromagnetic whiteboard eraser defines the rectangular erasing area by the same way. Therefore, the electromagnetic whiteboard eraser makes a mistake about defining the rectangular erasing area so the electromagnetic whiteboard eraser defines an rectangular erasing area which can not completely overlap the ink eraser. This erroneous erasing area causes the electromagnetic whiteboard eraser to erase the writing (or information) inputted by the electromagnetic induction, which the user does not want to erase, or causes the electromagnetic whiteboard eraser to be unable to the writing (or information) inputted by the electromagnetic induction, which the user want to erase. Therefore, it results in the difficulty in defining the erasing area.

Furthermore, a low power indicator 34 is deposed on the top housing 23 or in the top housing 23 (or in the eraser body 20) for giving an alarm when the power of the battery 29 is low. When the detecting circuit deposed on the control board 30 detects that the voltage or the charge of the battery 29 is in low state, the detecting circuit notifies the low power indicator 34 to give an alarm for reminding the user to change the battery 29. By this way, when the electromagnetic whiteboard eraser 10 erases on the electromagnetic whiteboard, the situation that the electromagnetic whiteboard eraser 10 is unable to emit the electromagnetic signals for being induced by the electromagnetic whiteboard caused by low voltage or low charge of the battery can be avoided. And the situation that the writing (or information) inputted by the electromagnetic induction cannot be erased by the electromagnetic whiteboard eraser 10 caused by low voltage or low charge of the battery also can be avoided. The low power indicator 34 is a LED or other indicator capable of emitting light or voice. Referring to FIG. 2A, in this embodiment, although the low power indicator 34 is deposed in the eraser body 20 and the low power indicator 34 is observed through an opening or a transparent area 23a deposed on the top housing 23, but in another embodiment, the low power indicator is deposed directly on the top housing.

The electromagnetic whiteboard eraser utilizes a coil, which is deposed in the eraser body and corresponds to the center of the circular ink eraser, to emit the electromagnetic signals and the electromagnetic whiteboard induces the electromagnetic signals to calculate the position of the coil and to define an erasing area. The electromagnetic whiteboard defines the position of the coil to be the center of the erasing area and defines the diameter or the radius of the ink eraser to be the diameter or the radius of the ink eraser of the erasing area for forming a circular erasing area completely overlapping the ink eraser. By this way, when the writing (or information) written by ink is erased by the ink eraser of the electromagnetic whiteboard eraser, the writing (or information) inputted by the electromagnetic induction is erased by the electromagnetic whiteboard eraser simultaneously. Furthermore, because the distances from the position of the coil to any point at the circumferences of the ink eraser and the circular bottom are the same, the electromagnetic whiteboard eraser can moves freely on the electromagnetic whiteboard toward any direction with any side of the electromagnetic whiteboard eraser for erasing Therefore, it does not influence the judgement of the electromagnetic whiteboard or it does not result in the difficulty in defining an erasing area. Furthermore, because a low power indicator is deposed on the top housing or in the top housing of the electromagnetic whiteboard, both of the situation that the electromagnetic whiteboard eraser 10 is unable to emit the electromagnetic signals for being induced by the electromagnetic whiteboard caused by low state of voltage or charge of the battery and the situation that the writing (or information) inputted by the electromagnetic induction cannot be erased by the electromagnetic whiteboard eraser 10 caused by low state of voltage or charge of the battery can be avoided. Therefore, this invention provides an electromagnetic whiteboard eraser capable of being applied to the electromagnetic whiteboard, erasing both of the writing written by ink and the writing inputted by electromagnetic induction simultaneously, and having an low power indicator.

Although the present invention will be described in accordance with the embodiments shown above, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. An electromagnetic whiteboard eraser, comprising:
an eraser body for the user to hold said electromagnetic whiteboard eraser with hand to erase the writing written by ink and the writing inputted by electromagnetic induction;
a control board deposed in said eraser body for controlling said electromagnetic whiteboard eraser;
a coil deposed in said eraser body for emitting a first electromagnetic signal or a second electromagnetic signal; and
an ink eraser deposed on the bottom of said eraser body for erasing the writing written by ink.

2. The electromagnetic whiteboard eraser of claim 1, wherein said eraser body comprises a left side housing, a right side housing, a top housing and a bottom housing, and any two or three housings of said left side housing, said right side housing, said top housing and said bottom housing are integrated as one member, or all of said left side housing, said right side housing, said top housing and said bottom housing are independent member.

3. The electromagnetic whiteboard eraser of claim 2, wherein both of said left side housing and said right side housing have a holding member outside said left side housing and said right side housing for the user to take and use said electromagnetic whiteboard eraser with hand conveniently.

4. The electromagnetic whiteboard eraser of claim 3, wherein said holding member is a concave for the user to conveniently hold with hand.

5. The electromagnetic whiteboard eraser of claim 2, wherein said bottom housing has a circular bottom and a holding cavity deposed in the center area of said circular bottom, and said holding cavity is sunken upward.

6. The electromagnetic whiteboard eraser of claim 5, wherein said coil is deposed at the center of said holding cavity for deposing said coil at both of the centers of said circular bottom and said holding cavity.

7. The electromagnetic whiteboard eraser of claim 6, wherein said holding cavity has two holes on the top of said holding cavity for passing the two ends of said coil through said holes to be connected with said control board.

8. The electromagnetic whiteboard eraser of claim 6, wherein said control board has a signal converting switch on the bottom of said control board for converting said first electromagnetic signal to said second electromagnetic signal and for converting said second electromagnetic signal to said first electromagnetic signal.

9. The electromagnetic whiteboard eraser of claim 8, wherein said first electromagnetic signal and said second electromagnetic signal have different frequencies, and said first electromagnetic signal is an original electromagnetic signal and said second electromagnetic signal is an erasing electromagnetic signal.

10. The electromagnetic whiteboard eraser of claim 9, wherein a controlling member is deposed on the top of said holding cavity for controlling said signal converting switch to be turned on or turned off.

11. The electromagnetic whiteboard eraser of claim 10, wherein when said electromagnetic whiteboard eraser erases on an electromagnetic whiteboard, said bottom housing is pressed to bring said controlling member to move upward to press or push said signal converting switch for turning on said signal converting switch, and then, said signal converting switch converts the electromagnetic signal emitted by said coil from said first electromagnetic signal to said second electromagnetic signal for starting to erase on said electromagnetic whiteboard.

12. The electromagnetic whiteboard eraser of claim 11, wherein when said electromagnetic whiteboard eraser moves away from said electromagnetic whiteboard, said bottom housing brings said controlling member to return to the original position and stops pressing or pushing said signal converting switch for turning off said signal converting switch, and then, said signal converting switch converts the electromagnetic signal emitted by said coil from said second electromagnetic signal to said first electromagnetic signal for stopping erasing on said electromagnetic whiteboard.

13. The electromagnetic whiteboard eraser of claim 10, wherein said controlling member is a protrusion.

14. The electromagnetic whiteboard eraser of claim 2, wherein said electromagnetic whiteboard eraser has a low power indicator deposed on said top housing or in said top housing for giving an alarm when the power of a battery is low.

15. The electromagnetic whiteboard eraser of claim 14, wherein said low power indicator is a LED.

16. The electromagnetic whiteboard eraser of claim 14, wherein a detecting circuit is deposed in said control board for detecting the state of voltage of said battery or the state of charge of said battery, and then, said detecting circuit notifies said low power indicator to give an alarm when the voltage or the charge of said battery is in low state.

17. The electromagnetic whiteboard eraser of claim 1, wherein an oscillating circuit is deposed in said control board for controlling said coil to emit the electromagnetic signals.

18. The electromagnetic whiteboard eraser of claim 1, wherein said eraser body has a battery container deposed therein for putting a battery therein to be a power supply of said electromagnetic whiteboard eraser.

19. The electromagnetic whiteboard eraser of claim 18, wherein said eraser body further comprises a battery cover for sealing said battery in said battery container and for changing said battery.

20. The electromagnetic whiteboard eraser of claim 6, wherein said ink eraser is a circular eraser having the same size with said circular bottom for making said coil to correspond to the center of said circular eraser.

21. The electromagnetic whiteboard eraser of claim 20, wherein an erasing area of said electromagnetic whiteboard eraser is formed by defining the position of the coil to be the center of said erasing area and defining the diameter or radius of said ink eraser to be the diameter or radius of said erasing area.
